(19) United States
(12) Patent Application Publication
(10) Pub. No.: US 2015/0129001 A1
(43) Pub. Date: May 14, 2015

(54) APPARATUS FOR CLEANING OFFICE MACHINE

(71) Applicant: Hee Jin KANG, Incheon (KR)

(72) Inventor: Hee Jin KANG, Incheon (KR)

(21) Appl. No.: 14/265,472

(22) Filed: Apr. 30, 2014

(30) Foreign Application Priority Data
Nov. 11, 2013 (KR) 10-2013-0136136

(51) Int. Cl. B08B 3/10

(52) U.S. Cl. CPC B08B 3/106
USPC 134/105

(57) ABSTRACT

Disclosed is an apparatus for cleaning office machine that is configured to easily and conveniently clean contaminants and stained dirt on the surfaces of an office machine using a cleaning apparatus without manually cleaning them wherein such contaminants and stained dirt are developed after a long term use of an office machine such as a scanner, a copy machine, a printer, a fax machine, a computer, etc. that are generally used in an ordinary office.

### TECHNICAL FIELD

The present invention relates to an apparatus for cleaning office machine, and in particular to an apparatus for cleaning office machine that is configured to easily and conveniently clean contaminants and stained dirt on the surfaces of an office machine using a cleaning apparatus without manually cleaning them wherein such contaminants and stained dirt are developed after a long term use of an office machine such as a scanner, a copy machine, a printer, a fax machine, a computer, etc. that are generally used in an ordinary office.

### BACKGROUND ART

Generally speaking, an office machine such as a scanner, a copy machine, a printer, a fax machine, a computer, etc. is a system that can enhance a productivity in business because they provide a worker with lots of helps during work. They are also used for an effective information management.

As a modern society develops, such an office machine is getting equipped with a combined function as compared with a simple function. More specifically, a conventional copy machine has provided only a simple copying function, but a new copy machine can provide a variety of functions such as a copying function, a fax function, a scanner function, a file format conversion function, etc.

There is a copy machine equipped with a variety of functions such as a fax function, a scanner function, a file format conversion function, etc., however it costs a lot to purchase such a new office machine. To improve this, most of companies use such a new office machine by renting at a relatively low cost from a rent company without paying an initial purchase cost and a maintenance cost.

When an office machine cannot be used anymore because of failures or the returns from the company that rented it, the parts of such an office machine are repaired and the exteriors are cleaned for the next rents. The repaired and cleaned office machine are finally checked out for their performance and exterior states and are rented again.

For the sake of repairs of the office machine, the Korean Patent Publication No. 10-2011-0088855 (hereinafter referred to “prior art”) describes a drum cleaning apparatus for an office machine that has features in that both the ends of a drum on which an image (character or picture) is formed for printing and toner is sprayed are cleaned in the interior of an office machine such as a copy machine or a printer.

When the office machine has a failure or when it is returned, the rent company disassembles the office machine so as to repair the parts for the sake of next rents. The contaminants and stained dirt on the surface of an external case corresponding to an exterior of the office machine among the disassembled parts are cleaned using a cleaning agent such as a nonionic surfactant, a natural fatty acid surfactant permeating agent, etc.

When cleaning the contaminants or stained dirt from an external case using such as a cleaning agent, if a corresponding office machine has been used for a long time, the contaminants or long stained dirt won't be well cleaned. In this case, the surface of an external case is first covered with a woven cloth or a tissue, and a cleaning agent is sprayed. So, the cleaning work should be performed after a certain swelling time, so it takes long to clean.

If the contaminants and stained dirt are not removed even through such procedure, it needs to perform the same procedures again. In this case, more woven cloths or tissue are necessary, thus consuming costs. Since more cleaning agent is used, it may not be good for a worker's health.

### PRIOR ART DOCUMENT

### Patent Document

(Patent Document 0001) Korean Patent Publication No. 10-2011-0088855

### DISCLOSURE OF THE INVENTION

Accordingly, it is an object of the present invention to provide an apparatus for cleaning contaminants and stained dirt that is configured to improve the problems that the contaminants and stained dirt on the surface of the external case of an office machine that have developed due to a long time use should be cleaned manually, and a certain article such as a woven cloth or a tissue should be used in the course of cleaning such contaminants and stained dirt, and the worker who should work manually is exposed to a cleaning agent, so the workers health may be harmed.

To achieve the above objects, there is provided an apparatus for cleaning an office machine that comprises a body unit that includes an inner space, a first discharge port formed in a bottom surface of the inner space to discharge a cleaning agent and a plurality of support members provided in its bottom surface and spaced apart from the ground; a corrosion prevention unit that is engaged to the interior of the body unit, wherein a second discharge port inserted in the interior of a first discharge port provided in the bottom surface of the interior of the body unit is provided in a bottom surface of the inner space; a plurality of support members that are engaged with bolts “B” to an inner side of the corrosion prevention unit; a cleaning agent storing unit that is mounted on the support member and is positioned in the interior of the corrosion prevention unit and is provided in a protruded shape, wherein a cleaning agent is stored in each protruded groove, and a third discharge port to which a rubber stopper “S” is engaged is provided in the bottom surface of the protruded groove 46 such that the cleaning agent in the protruded groove can be discharged, and the disassembled outer case “C” of the office machine is mounted on its top; a plurality of heat source emission units that are spaced apart and are mounted on the upper surface and the lower surface of the body unit so that the cleaning agent stored in the protruded groove of the cleaning agent storing unit can be sprayed by heat; and a transparent cover unit that includes a handle by which the cleaning agent sprayed by the heat from the heat emission unit is not discharged outside.

In addition, a sealing member is engaged to the upper surface of the body unit so as to prevent the cleaning agent from being discharged outside wherein the cleaning agent is sprayed between the body unit and the cover unit 60 mounted on the upper surface of the body unit.

In addition, the corrosion prevention unit is made from a material between a rubber material and a synthetic resin material.

In addition, the bottom surface of the body unit and the bottom surface of the corrosion prevention unit decline downward, so the cleaning agent can be smoothly discharged.

In addition, the bottom surface of the protruded groove of the cleaning agent storing unit decline downward, so the cleaning agent can be smoothly discharged.

In addition, the heat source emission unit is either a florescent lamp or a halogen lamp.

In addition, a blower is engaged to an inner side of the corrosion prevention unit so that the cleaning agent sprayed by the heat from the heat source emission unit can be uniformly sprayed in the interior of the corrosion prevention unit.

In addition, a water washing unit is installed at an outer side of the body unit and includes a hollow water discharge port that is provided in a bottom surface of an inner space and is equipped with a rubber stopper “S”, wherein the bottom surface declines downward, and the water washing unit comprises a plurality of support members that are disposed on a lower surface and are spaced apart from the ground.

### Advantageous Effects

In an apparatus for cleaning an office machine according to the present invention, a worker does not need to manually clean the contaminants and dirt on the surface of an outer case of an office machine while spraying a cleaning agent. In the present invention, it is possible to clean a plurality of external cases at one time using a cleaning apparatus of the present invention, thus saving cleaning time.

In the present invention, since the contaminants and stained dirt on the surface of an external case of an office machine can be cleaned in the interior of the apparatus for cleaning an office machine of the present invention, so it is possible to prevent to the max the cleaning agent harmful to the worker from exposing to the worker, thus protecting a worker's health.

### BRIEF DESCRIPTION OF THE DRAWINGS

The present invention will become better understood with reference to the accompanying drawings which are given only by way of illustration and thus are not limitative of the present invention, wherein;

FIG. 1 is a disassembled perspective view illustrating an apparatus for cleaning an office machine according to the present invention;

FIG. 2 is a perspective view illustrating an engaged state of FIG. 1;

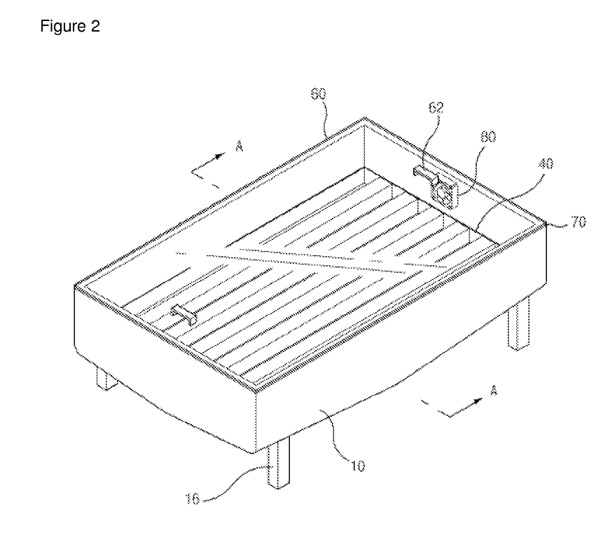

FIG. 3 is a cross sectional view taken along line A-A of FIG. 2;

FIG. 4 is a schematic cross sectional view illustrating a body unit, a corrosion prevention unit and a cleaning agent storing unit according to the present invention; and

FIG. 5 is a perspective view illustrating a water washing unit disposed at one side of an apparatus for cleaning an office machine according to the present invention.

### MODES FOR CARRYING OUT THE INVENTION

The constructions and operations of the apparatus for cleaning an office machine will be described with reference to the accompanying drawings.

The bottom surfaces 14, 24, 44, and 94 indicating the same components in the construction of the present invention represent the bottom surface of an inner space of each of a body unit 10, a corrosion prevention unit 20, a protruded groove 90 of a cleaning agent storing unit 4 and a water washing unit 90. Such components are given the same reference numeral in the present invention; however a bottom surface of each construction is given a different reference numeral.

The rubber stopper “S” represents the same component and will be described with the same terminology and reference numeral.

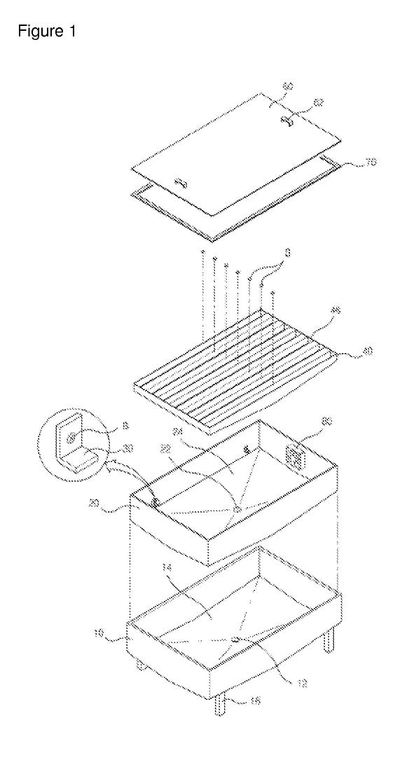

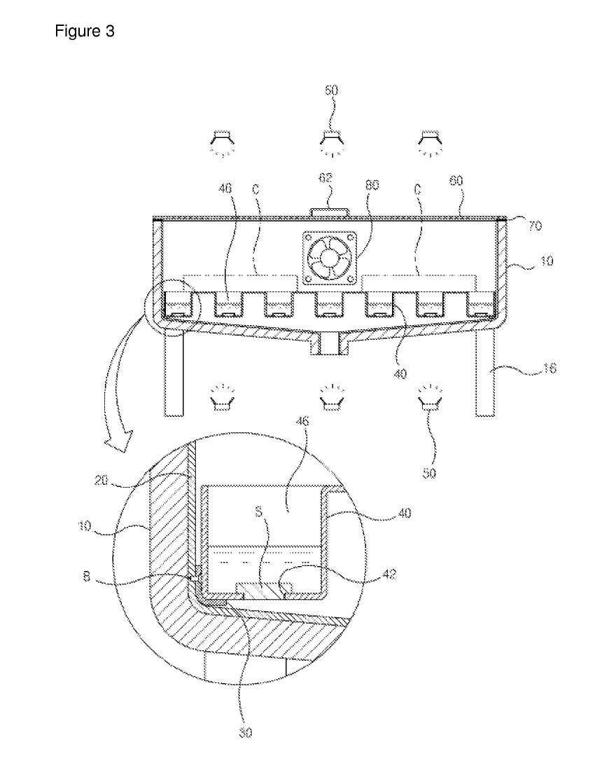

As shown in FIGS. 1 and 3, the apparatus for cleaning an office machine according to the present invention comprises a body unit 10, and a first discharge port 12 through which to discharge a cleaning agent to a bottom surface 14 of an inner space of the body unit 10.

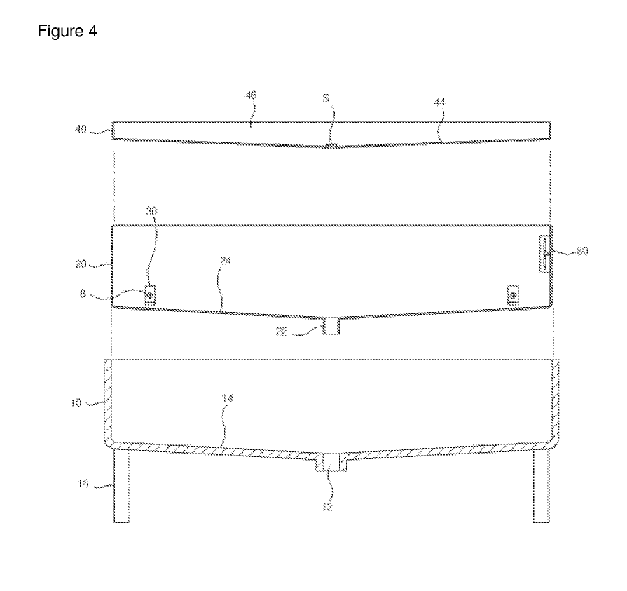

As shown in FIG. 4, the bottom surface 4 of the body unit 10 declines downward so that the cleaning agent from the first discharge port 12 can be easily discharged.

In addition, a plurality of support members 16 are provided beneath the body unit 10, thus supporting the body unit 10 while keeping a certain space from the ground.

In addition, the body unit 10 may be made from a certain material between a synthetic resin material or a metallic material. The material of the body unit 10 was selected because it had a good heat conduction property wherein the heat comes from a heat source emission unit 50. The present invention does not limit the material thereto. Any material having a good heat conduction property can be also used.

There is further included a corrosion prevention unit 20 that is engaged to the interior of the body unit 10.

The corrosion prevention unit 20 has a hollow space in its interior, and on the bottom surface 24 of the inner space is provided a second discharge port 22 through which to discharge a cleaning agent.

At this time, when the corrosion prevention unit 20 is engaged to the interior of the body unit 10, the second discharge port 22 of the corrosion prevention unit 20 is inserted in the interior of the first discharge port 12 of the body unit 10. As shown in FIG. 4, the bottom surface 24 of the corrosion prevention unit 20 declines downward so that the cleaning agent can be smoothly discharged downward.

The material of the corrosion prevention unit 20 is selected from a rubber material and a synthetic resin material.

When a cleaning agent sprays in the interior of the corrosion prevention unit 30, it is possible to prevent the corrosions of the corrosion prevention unit 20 while preventing the corrosions of the body unit 10.

A plurality of support members 30 are engaged to the side surface of the interior of the corrosion prevention unit 20 using bolts “B”, and a cleaning agent storing unit 40 is mounted on the upper surface of the support member 30 and is positioned in the interior of the corrosion prevention unit 20.

As shown in FIG. 3, the interior of the cleaning agent storing unit 40 is configured in a protruding shape, and cleaning agent is stored in each protruded groove 46 between the protrusions. The cleaning agent is a nonionic surfactant or a natural fatty acid surfactant permeating agent both available in the market.

A third discharge port 42 is formed on the bottom surface of the protruded groove 46 so that the cleaning agent in the protruded groove 46 can be discharged. A rubber stopper “S” is engaged to the third discharge port 42. The disassembled external case “C” of the office machine is placed on the upper surface of the cleaning agent storing unit 40.

Here, the external case of the office machine is a case that is engaged to an outer side of the office machine such as a scanner, a copy machine, a printer, a fax machine, a computer, etc.

As shown in FIG. 4, the bottom surface 44 of the protruded groove 46 in which is stored a cleaning agent declines downward so that the cleaning agent from the third discharge port 42 can smoothly discharge.

In addition, a plurality of heat source emission units 50 are spaced apart on the upper surface and the lower surface of the cleaning agent storing unit 40. The heat source emission unit 50 is selected between a fluorescent lamp and a halogen lamp.

Here, the heat source emission unit 50 is used for a heat source purpose so that the cleaning agent stored in the protruded groove 46 of the cleaning agent storing unit 40 can be sprayed by the heat emitted from the heat source emission unit 50. It is also used for a lighting purpose so as to check a cleaning state of the contaminants and stained dirt of the external case “C” of the office machine.

In the present invention, there is further included a transparent cover unit 60 equipped with a handle 62 that is configured to prevent the cleaning agent from be discharged outside wherein the cleaning agent is sprayed by the heat from the heat source emission unit 50. The cover unit 60 is mounted on the upper surface of the body unit 10.

At this time, a sealing member 70 made from a rubber material or a silicon material is engaged using an adhesive or a bolt to the upper surface of the body unit 10 so that the cleaning agent sprayed between the body unit 10 and the upper surface of the body unit 10 cannot be discharged outside.

The cover unit 60 is made from a transparent material so as to often visually check out the removing states of the contaminants and stained dirt on the surface of the external case “C” or the internal states of the corrosion prevention unit 20.

To the inner side of the corrosion prevention unit 20 is engaged a blower that operates by an electric power so that the cleaning agent sprayed in the interior of the corrosion prevention unit 20 can be uniformly sprayed in the interior of the corrosion prevention unit 20.

More specifically, the cleaning agent that is sprayed over the surface of the external case “C” of the office machine mounted on the top of the cleaning agent storing unit 40 can be uniformly distributed, thus effectively removing contaminants and stained dirt.

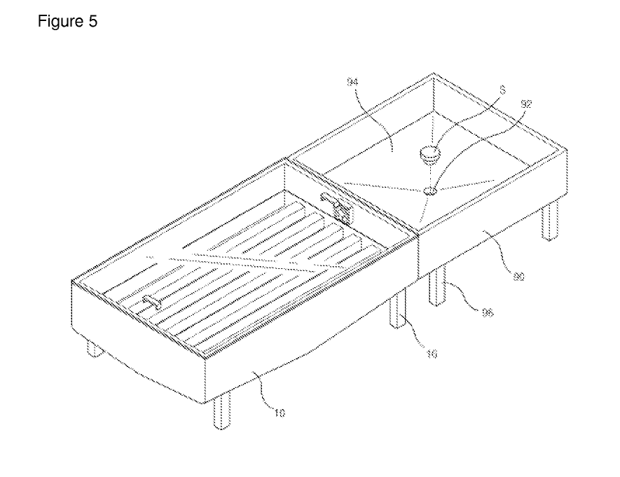

As shown in FIG. 5, there is provided a water washing unit 90 at an outer surface of the body unit 10.

Here, the water washing unit 90 has a hollow space in its interior, and in the bottom surface 94 of the inner space is provided a water discharge port 92 equipped with a rubber stopper “S”. In the bottom surface 94 is provided a water washing unit 90 that declines downward. A plurality of support members 96 are provided in the bottom surface of the water washing unit 90 while supporting the water washing unit 90 and keeping from the ground.

Here, the water washing unit 90 is used for rinsing with water the external case “C” of the office machine from which contaminants and stained dirt are removed by the cleaning agent that is spraying in the interior of the corrosion prevention unit 20. After the rinsing process is finished, the rubber stopper “S” engaged to the water discharge port 92 is disengaged, thus discharging the water.

The cleaning procedure of the apparatus for cleaning an office machine will be described.

First of all, the outer case “C” separated from the office machine is washed with water in order to remove impurities such as dust, etc. The water is removed from the outer case “C” by shaking it. The outer case is mounted on top of the cleaning agent storing unit 40 positioned in the corrosion prevention unit 20.

Next, the cover unit 60 is mounted on the upper surface of the body unit 10 and is covered, and electric power is supplied to the heat source emission unit 50 that is disposed on the upper surface and lower surface of the body unit 10.

Heat generates in the heat source emission unit 50, and the heat is transferred to the cover unit 60 positioned on the upper surface of the body unit 10, so the temperature of the cover unit 60 increases. The heat generating from the heat emission unit 50 positioned on the lower surface of the body unit 10 is transferred to the lower surface of the body unit 10, so the temperature of the body unit 10 increases.

As the heat is transferred to both the cover unit 60 and the body unit 10, and the temperature increases, the temperature in the interior of the corrosion prevention unit 20 increases, and the temperature of the cleaning agent in the protruded groove 46 of the cleaning agent storing unit 40 increases. The spraying cleaning agent covers over the surface of the outer case “C”, thus removing the contaminants and stained dirt, so the outer case “C” turns its initial color.

If the outer case “C” mounted on top of the cleaning agent storing unit 40 is too big or is stacked or if the contaminants and stained dirt are too dense, electric power is supplied to the blower 80 installed on an inner side of the corrosion prevention unit 20.

The cleaning agent sprayed by the wind from the blower 80 sprays in all directions, and the cleaning agent can be coated on every portion of the outer cases “C”, thus more effectively removing the dense contaminants and stained dirt while saving a cleaning time.

In addition, the outer case “C” from which the contaminants and stained dirt are removed is moved to the water washing unit 90 and is washed a few times, and the water is removed naturally or using a woven cloth, and is assembled to the office machine.

Since part of the washing agent remains in the water in the water washing unit 90, it is not drained to a drain pipe, but is collected in a separate container and is sent to an official waste treatment company.

The cleaning agent in the protruded groove 46 of the cleaning agent storing unit 40 can be discharged by removing the rubber stopper “S” from the third discharge port 42 provided in the bottom surface 44 of the protruded groove 46. The discharged cleaning agent is discharged through the bottom surface 24 of the corrosion prevention unit 20 through the second discharge port 22.

At this time, the bottom surface 44 of the protruded groove 46 and the bottom surface 24 of the corrosion prevention unit 20 decline downward, so all the cleaning agent stored in the protruded groove 46 are discharged. The collected cleaning agent is stored in a separate container and is set to an official waste treatment company.

What is claimed is:

1. An apparatus for cleaning an office machine, comprising:
a body unit 10 that includes an inner space, a first discharge port 12 formed in a bottom surface 14 of the inner space to discharge a cleaning agent and a plurality of support members 16 provided in its bottom surface and spaced apart from the ground;
a corrosion prevention unit 20 that is engaged to the interior of the body unit 10, wherein a second discharge port 22 inserted in the interior of a first discharge port 12 provided in the bottom surface 14 of the interior of the body unit 10 is provided in a bottom surface 24 of the inner space;
a plurality of support members 30 that are engaged with bolts “B” to an inner side of the corrosion prevention unit 20;
a cleaning agent storing unit 40 that is mounted on the support member 30 and is positioned in the interior of the corrosion prevention unit 20 and is provided in a protruded shape, wherein a cleaning agent is stored in each protruded groove 46, and a third discharge port 42 to which a rubber stopper “S” is engaged is provided in the bottom surface 44 of the protruded groove 46 such that the cleaning agent in the protruded groove 46 can be discharged, and the disassembled outer case “C” of the office machine is mounted on its top;
a plurality of heat source emission units 50 that are spaced apart and are mounted on the upper surface and the lower surface of the body unit 10 so that the cleaning agent stored in the protruded groove 46 of the cleaning agent storing unit 40 can be sprayed by heat; and
a transparent cover unit 60 that includes a handle 62 by which the cleaning agent sprayed by the heat from the heat emission unit 50 is not discharged outside.

2. The apparatus of claim 1, wherein a sealing member 70 is engaged to the upper surface of the body unit 10 so as to prevent the cleaning agent from being discharged outside wherein the cleaning agent is sprayed between the body unit 10 and the cover unit 60 mounted on the upper surface of the body unit 10.

3. The apparatus of claim 1, wherein the corrosion prevention unit 20 is made from a material between a rubber material and a synthetic resin material.

4. The apparatus of claim 1, wherein the bottom surface 14 of the body unit 10 and the bottom surface 24 of the corrosion prevention unit 20 decline downward, so the cleaning agent can be smoothly discharged.

5. The apparatus of claim 1, wherein the bottom surface 44 of the protruded groove 46 of the cleaning agent storing unit 40 decline downward, so the cleaning agent can be smoothly discharged.

6. The apparatus of claim 1, wherein the heat source emission unit 40 is either a florescent lamp or a halogen lamp.

7. The apparatus of claim 1, wherein a blower 80 is engaged to an inner side of the corrosion prevention unit 20 so that the cleaning agent sprayed by the heat from the heat source emission unit 50 can be uniformly sprayed in the interior of the corrosion prevention unit 20.

8. The apparatus of claim 1, wherein a water washing unit 90 is installed at an outer side of the body unit 10 and includes a hollow water discharge port 92 that is provided in a bottom surface 94 of an inner space and is equipped with a rubber stopper “S”, wherein the bottom surface 94 declines downward, and the water washing unit 90 comprises a plurality of support members 96 that are disposed on a lower surface and are spaced apart from the ground.
